(19) United States
(12) Patent Application Publication
(10) Pub. No.: US 2020/0014274 A1
(43) Pub. Date: Jan. 9, 2020

(54) STATOR FOR ELECTRIC MOTOR

(71) Applicant: MOTEURS LEROY-SOMER, Angouleme Cedex 9 (FR)

(72) Inventors: Benoit Petitgas, Angouleme (FR); Nicolas Tanguy, Angouleme (FR); Anne Gimenez, Saint-Yrieix (FR); Joel Lassoudiere, Villefagnan (FR)

(73) Assignee: MOTEURS LEROY-SOMER, Angouleme Cedex 9 (FR)

(21) Appl. No.: 16/504,080

(22) Filed: Jul. 5, 2019

(30) Foreign Application Priority Data
Jul. 5, 2018 (FR) 18 56191

(51) Int. Cl. H02K 3/52; H02K 1/16; H02K 3/34; H02K 15/00; H02K 15/12; H01B 3/30; H01B 3/42; H01B 3/40; H01B 3/46

(52) U.S. Cl. CPC H02K 3/522; H02K 1/16; H02K 3/34; H02K 15/0018; H01B 3/46; H01B 3/306; H01B 3/427; H01B 3/40; H02K 15/12

(57) ABSTRACT

The invention relates to a stator for an electric motor, including at least one winding of a wire made of an electrical conductor composed primarily of aluminum covered with a thickness of between 30 and 100 μm of an insulator including at least one polymer chosen from among the polyaryletherketones (PAEK).

The present invention relates to a stator for an electric motor, and, more particularly, to a stator for a motor for a compressor operating with ammonia as the refrigerant.

Freon gases are harmful for the environment since they are powerful greenhouse gases and damage the ozone layer.

To reduce these negative effects on the environment, the refrigeration industry, which makes heavy use of freon gases, is seeking to replace them with “cleaner” gases, such as ammonia.

A number of known setups now use ammonia as the heat transfer fluid. However, in these setups, the gas never flows through the air gap of the stator/rotor of the rotary machine. The motor, which drives the elements used for compressing the gas, and is referred to as an open compressor in this type of setup, is located outside the compressor.

The invention aims to introduce the stator/rotor assembly into the compressor. This assembly, also referred to as a semi-sealed or sealed unit, is more compact than the setups using open compressors. Moreover, under certain conditions, these setups may be just as effective as those using freon gases.

Additionally, the performance of a rotary machine depends in particular on the electrical conductor with which it is wound. Conventionally, copper is used because of its good electrical and thermal conduction properties.

Application JP2004031253 describes an enameled wire that can be used in ammonia. It is manufactured based on an aluminum conductor and a PPS insulator, which is applied using existing methods for conventional enameling.

Application CN103138451 discloses an ammonia-resistant motor with a PPS-covered aluminum conductive wire.

U.S. Pat. No. 8,006,514 discloses a conductor covered with a fluorinated resin, this conductor preferably being made of aluminum.

U.S. Pat. No. 7,082,786 describes a refrigeration system fitted with a scroll compressor operating with ammonia. The winding of the motor driving the compressor is an aluminum conductor covered with a fluorinated resin.

Application CN205406121 discloses a copper/aluminum/copper-clad aluminum multilayer conductor, insulated by a first, polyesterimide tie layer, by a second, polyamide-imide layer and by a third, polytetrafluoroethylene layer.

Application DE102013017147A1 presents the manufacture of a screw compressor for sealed application, using ammonia as the heat transfer fluid. The stator of the compressor is wound with a copper conductive wire, unlike the prior art which is based on designs using aluminum wires. The insulation for the copper takes up several hundreds of microns, which limits the slot-fill factor and hence the performance of the setup.

The difficulty with a semi-sealed compressor operating in ammonia lies in finding components, in particular the electrically conductive wire for the windings, that are compatible with the presence of ammonia, and remain so for the entire service life of the compressor.

“Standard” components, used in rotary machines that are not exposed to ammonia, degrade very rapidly in ammonia, resulting in insulation faults in the stator and the compressor stopping.

The invention aims to further refine the electric stators for motors that are intended to operate while exposed to ammonia, in particular from the point of view of electrical performance and length of service life.

The invention achieves this objective by virtue of a stator for an electric motor, including at least one winding of a wire made of an electrical conductor composed primarily of aluminum covered with a thickness of between 30 and 100 μm of an insulator including at least one polymer chosen from among the polyaryletherketones (PAEK).

Tests have demonstrated that such a stator exhibits excellent resistance to ammonia while providing a good slot-fill factor, hence high electrical performance. This manifests as several additional efficiency points, in comparison with a stator manufactured using heavily insulated copper conductors, such as defined in patent DE102013017147A1.

Aluminum, because of its poor electrical connectivity in comparison with copper, hinders the performance of the motor and hence of the compressor, although it is compatible with ammonia. The PAEK family exhibits remarkable resistance to ammonia, thereby ensuring the reliability of the stator and hence of the compressor.

The thinness of the insulation allows a high slot-fill factor to be maintained, and hence a compact design to be favored.

In comparison with the invention, the choice of conductors made of copper insulated by coatings of several hundreds of microns, such as envisaged in application DE102013017147A1, results in the slots of the stator not being able to be filled to a high degree, with a loss ranging from 20 to 50% with respect to a standard fill.

The invention thus allows a slot-fill factor close to that of a standard fill.

Preferably, the insulator includes at least one polyaryletherketone (PAEK), and is preferably made of PEEK.

Preferably, the slot-fill factor of the stator is higher than 50%. The slot-fill factor is defined as the ratio of the total cross section of the electrical conductor in the slot to the total cross section of the slot.

The stator is preferably impregnated with an epoxy resin, with a polyesterimide enamel or with a silicone.

The stator preferably includes a sheet of an aramid-based insulator, of a fluorinated resin, in particular of PTFE, or of PEEK, around the phase windings, in the slots.

The stator may include heat-shrink tubing made of polyolefin material, for marking the phases.

The bundles of electrical conductors are preferably held in place outside the slots by an aramid cord.

The term “primarily of aluminum” should be understood to mean an aluminum content of the conductive metal material of at least 50%, preferably 80% and even more preferably 95% by weight. Preferably, the electrical conductor is composed entirely of aluminum.

Another subject of the invention is an electric motor including a stator according to the invention, such as defined above.

Yet another subject of the invention is a compressor operating with ammonia as the refrigerant, including a motor according to the invention.

This compressor is preferably a semi-sealed, piston, scroll, screw or centrifugal compressor, the ammonia being used as the heat transfer fluid in a refrigeration setup.

The invention will be able to be better understood upon reading the following detailed description of non-limiting exemplary implementations thereof, and upon examining the appended drawing, in which:

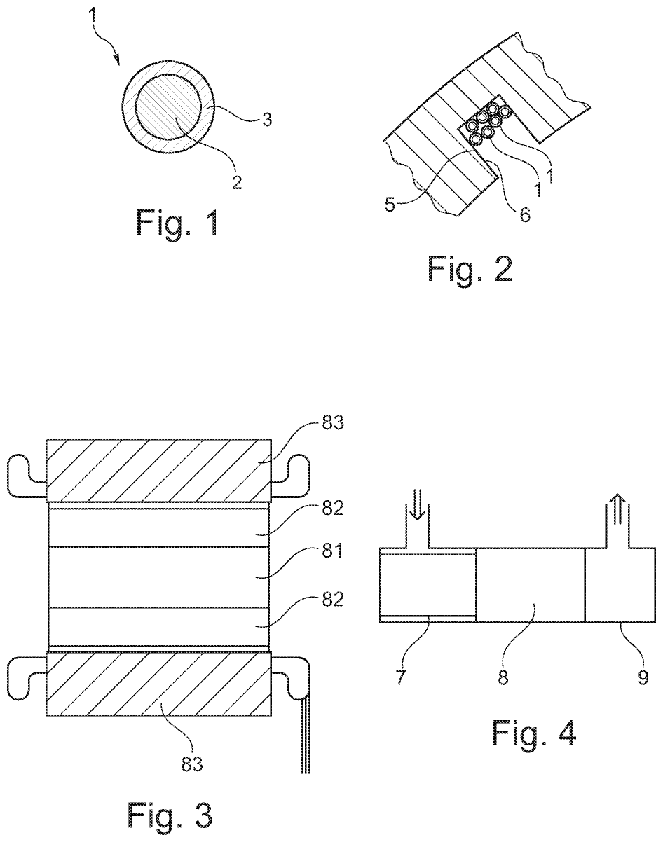

FIG. 1 schematically shows, in section, an example of a conductive wire according to the invention;

FIG. 2 illustrates the filling of a slot of the stator;

FIG. 3 schematically shows a motor according to the invention; and

FIG. 4 schematically shows a compressor according to the invention.

### CONDUCTIVE WIRE

FIG. 1 shows an example of a conductive wire according to the invention. This conductive wire 1 includes a metal electrical conductor 2 and an insulating coating 3.

The electrical conductor is made primarily from aluminum, or is even composed exclusively of aluminum.

Its cross section may be circular or otherwise, in particular square or rectangular, which may make it possible to produce, if required, an ordered winding, having a better slot-fill factor.

The cross section of the electrical conductor ranges from 1 to 7 mm², for example, depending on the power of the motor.

The insulating coating 3 is based on PAEK, preferably on PEEK.

The coating may be entirely composed of PEEK.

The wire may be manufactured using an extrusion process. The tolerances on the outer diameter of the insulated wire are +/−15 μm.

It is possible to combine, as required, PAEK with other polymers such as polyamide-imide or even polyphenylene sulfide (PPS), either alone or else combined with polyphenylsulfone (PPSU) polyolefin polyalkenes or polyethersulfone (PESU), or any other resin having a glass transition temperature (T_{g}) that is higher than 150° C.

The coating is between 30 and 100 μm, preferably between 30 and 50 μm, in thickness.

Stator

The stator includes a magnetic circuit, which may be of any type, including slots within which the phase windings are accommodated.

FIG. 2 shows such a slot 5 and a portion of the conductive wires 1 accommodated within.

The number of slots depends on the polarity of the motor. The motor may be synchronous or asynchronous, but preferably synchronous. The number of poles ranges from 2 to 8, for example. The power of the motor ranges from 0.5 to 400 kW, for example.

The stator may be impregnated using a coating or impregnation epoxy resin. It may also be impregnated with polyesterimide enamel or silicone.

The slots and the phases may be insulated with sheets 6 of an insulator, for example PTFE, PEEK or aramid papers.

The conductive wires may be laced using aramid cord.

The phases may be marked using polyolefin heat-shrink tubing.

FIG. 3 shows a motor comprising a stator 83 according to the invention and a rotor 81 with poles 82.

FIG. 4 shows a compressor comprising a motor 8 according to the invention, with an inlet stage 7 and an outlet 9.

Comparative Tests

A number of tests have been carried out with an aluminum wire coated with different thicknesses of insulator.

TABLE 1

| | | Breakdown voltage (kV) | | | | |
|---|---|---|---|---|---|---|
| | Insulation | | After aging | | | |
| | radius | Before aging | from | Thermal | | |
| Wire | (mm) | from ammonia | ammonia | shock | Abrasion | Fill (%) |
| Insulator n^{o}1 | 0.407 | >15 | >15 | OK | OK | 19.9 |
| Insulator n^{o}2 | 0.373 | >15 | >15 | OK | OK | 25.2 |
| Insulator n^{o}3 | 0.232 | >15 | >15 | OK | OK | 29.7 |
| Insulator n^{o}4 | 0.075 | 8 | 11.5 | OK | OK | 50.1 |
| Standard | 0.040 | 5 | 0 | OK | OK | 50-60 |
| insulator | | | | | | |

The insulators 1 to 4 consist of various thicknesses of PEEK.

The standard insulator consists of copper enameled with PEI (polyesterimide)/PAI (polyamide-imide). It can be seen that insulator n° 4, according to the invention, retains good mechanical strength and electrical resistance after aging in contact with ammonia, as well as a good slot-fill factor, higher than 50%.

1. A stator for an electric motor, the stator including at least one winding of a wire made of an electrical conductor composed primarily of aluminum covered with a thickness of between 30 and 100 μm of an insulator including at least one polymer chosen from among the polyaryletherketones (PAEK).

2. The stator according to claim 1, the insulator including at least polyether ether ketone (PEEK).

3. The stator according to claim 1, the slot-fill factor of the stator being higher than 50%.

4. The stator according to claim 1, being impregnated with an epoxy resin, with a polyesterimide enamel or with a silicone.

5. The stator according to claim 1, including a sheet of an aramid-based insulator, of a fluorinated resin, in particular of PTFE, or of PEEK, around the phase windings.

6. The stator according to claim 1, the electrical conductor being composed entirely of aluminum.

7. An electric motor including a stator according to claim 1.

8. A compressor operating with ammonia as the refrigerant, including an electric motor according to claim 7.
